(19) United States
(12) Patent Application Publication
(10) Pub. No.: US 2011/0175362 A1
(43) Pub. Date: Jul. 21, 2011

(54) DYNAMIC FLUID ENERGY CONVERSION

(76) Inventor: Fernando Gracia Lopez, Garza Garcia (MX)

(21) Appl. No.: 12/690,805

(22) Filed: Jan. 20, 2010

(51) Int. Cl. F03D 9/00; F04B 41/06

(52) U.S. Cl. 290/55; 417/521

(57) ABSTRACT

Converting the dynamic energy of a fluid to generate electrical power may be accomplished by a variety of systems, processes, devices, and techniques. In particular, implementations, the movements of a gaseous fluid body may be used for generating electrical power by driving a pump using the motion of a flow-driven moveable member that rotates in response to movement of the fluid body. The driving of the pump may pressurize a pumping fluid with pistons located in multiple chambers of the pump, and the pressurized pumping fluid may be conveyed to an electrical power generator mechanism that generates electrical power using the pressurized pumping fluid.

### BACKGROUND

As the world continues to become more socially and economically advanced, its need for energy will continue to grow. Additionally, as the world's population continues to increase, its energy needs will grow. Thus, the need for energy will continue to expand.

Many traditional techniques for producing energy (e.g., combusting coal or natural gas) have become increasingly expensive with increased energy demand. Also, these techniques, as well as alternative techniques (e.g., nuclear), have numerous environmental drawbacks. Other traditional techniques (e.g., geo-thermal and hydro-electric) have not been able to keep pace with demand.

### SUMMARY

This disclosure relates to systems, processes, devices, and techniques for converting the dynamic energy of a fluid body. In particular implementations, the dynamic energy of a gaseous fluid body may be converted into electrical power.

In one general aspect, a system for utilizing movements of a gaseous fluid body to generate electrical power may include a first pumping mechanism and an electrical power generating mechanism. The pumping mechanism may include a flow-driven moveable member adapted to rotate in response to movement of a gaseous fluid body and a pump coupled to the moveable member and adapted to pressurize a pumping fluid in response to motion of the moveable member. The moveable member may, for example, include a hub to which radially extending elements are coupled and an alignment system adapted to align the member with fluid body movements. The pump, for example, may include a multi-chambered cylinder, a plunger extending through the multi-chambered cylinder and driven by the moveable member; and a plurality of pistons coupled to the plunger. Each piston may be disposed in a separate chamber of the multi-chambered cylinder, and the plurality of pistons adapted to pressurize a pumping fluid in response to motion of the moveable member. The electrical power generation mechanism may be adapted to utilize the pressurized pumping fluid to generate electrical power.

The system may also include a conduit system for combining the pressurized pumping fluid from the chambers and conveying the combined fluid to the power generation mechanism. Additionally, the system may include a housing having an inner chamber from which the pump draws the fluid to be pressurized. The inner chamber may serve as a reservoir for multiple pumping cycles worth of the pumping fluid.

In certain implementations, the system may also include at least one fluid inlet conduit coupled to one of the chambers, a first one-way valve coupled to the at least one fluid inlet conduit, at least one fluid outlet conduit coupled to the chamber, and a second one-way valve coupled to the at least one fluid outlet conduit.

Particular implementations may also include a second pumping mechanism. The second pumping mechanism may, for example, include a flow-driven moveable member adapted to rotate in response to movement of a gaseous fluid body and a pump coupled to the moveable member and adapted to pressurize a pumping fluid in response to motion of the moveable member. The pump may, for example, include a multi-chambered cylinder, a plunger extending through the multi-chambered cylinder and driven by the moveable member, and a plurality of pistons coupled to the plunger. Each piston may be disposed in a separate chamber of the multi-chambered cylinder, and the plurality of pistons may be adapted to pressurize a pumping fluid in response to motion of the moveable member.

Some of these implementations may include a conduit system for combining the pressurized pumping fluid from the first pumping mechanism and the second pumping mechanism and conveying the combined fluid to the power generation mechanism. The system may also be adapted to allow the second pumping mechanism to cease supplying pressurized pumping fluid while the first pumping mechanism continues supplying pressurized pumping fluid. For example, the system may be adapted to allow the second pumping mechanism to be replaced while the first pumping mechanism continues supplying pressurized pumping fluid.

Certain implementations may include a second conduit system for dispersing the fluid from the power generation mechanism to the pumping mechanisms. The system may also include a bypass conduit in communication with the first conduit system and the second conduit system and a bypass valve coupled to the bypass conduit, the bypass valve adapted to allow flow of the pressurized pumping fluid from the first conduit system to the second conduit system when a predetermined pressure of the pumping fluid is exceeded.

In some implementations, the system may include a second electrical power generation mechanism adapted to utilize the pressurized pumping fluid to generate electrical power, and a first conduit system configured to convey the pressurized pumping fluid away from the pumping mechanism. A flow selector may coupled to the fluid conduit system and the inlet of at least one power generation mechanism and be configured to control fluid flow to at least one of the power generation mechanisms based on the fluid pressure in the first conduit system. The flow selector may, for example, include a valve in one of the supply inlets, a sensor for sensing the fluid pressure in the first conduit system, and a controller for generating a command for the valve based on the fluid pressure in the first fluid conduit system. The system may also include a second conduit system configured to convey the pressurized pumping fluid away from the electrical power generation mechanisms and to the pumping mechanism.

In another general aspect, a process for utilizing movements of a gaseous fluid body to generate electrical power may include driving a multi-chambered pump using the rotation of a flow-driven moveable member that rotates in response to movement of a gaseous fluid body and pressurizing a pumping fluid with pistons located in the chambers of the pump. The process may also include conveying the pressurized pumping fluid to an electrical power generator mechanism and generating power with the electrical power generator mechanism using the pressurized pumping fluid.

In certain implementations, the process may also include combining the pressurized pumping fluid from the chambers and conveying the combined fluid to the electrical power generator mechanism. The pumping fluid may be provided to an inner chamber of a housing from which the pump draws the fluid to be pressurized. The chamber may serve as a reservoir for multiple cycles worth of the pumping fluid.

In particular implementations, the process may also include driving a second multi-chambered pump using the rotation of a second flow-driven moveable member that rotates in response to movement of a gaseous fluid body, pressurizing the pumping fluid with pistons located in the chambers of the second pump, conveying the pressurized pumping fluid to the electrical power generator mechanism, and generating power with the electrical power generator mechanism using the pressurized pumping fluid from the first pump and the second pump.

Certain implementations may include combining the pressurized pumping fluid from the first pump and the second pump before it arrives at the electrical power generator mechanism. Some implementations may include ceasing to supply pressurized pumping fluid to the electrical power generator mechanism from the second pump while continuing to supply pressurized pumping fluid from the first pump.

Some implementations also include conveying pressurized pumping fluid to a flow selector before conveying it to the electrical power generator mechanism and adjusting fluid flow to the electrical power generator mechanism and a second electrical power generator mechanism based on the pressure of the pumping fluid.

In one general aspect, a system for utilizing movements of a gaseous fluid body to generate electrical power may include a first and second pumping mechanism and a plurality of power generation mechanisms. The pumping mechanisms may include a flow-driven moveable member, a power conversion mechanism, and a pump. The flow driven member may be adapted to rotate in response to movement of a gaseous fluid body and include radially extending elements coupled to a hub and an alignment system adapted to align the member with fluid body movements. The power conversion mechanism may be adapted to convey power from the moveable member to the pump, which may be coupled to the moveable member and adapted to pressurize a pumping fluid in response to motion of the moveable member. The pump may include a multi-chambered cylinder, a plunger extending through the multi-chambered cylinder and driven by motion of the moveable member, and a plurality of pistons coupled to the plunger. Each piston may be disposed in a separate chamber of the multi-chambered cylinder, and the plurality of pistons may be adapted to pressurize a pumping fluid in response to motion of the moveable member. Each chamber may include at least one fluid inlet conduit coupled to one of the chambers, a first one-way valve coupled to the at least one fluid inlet conduit, a least one fluid outlet conduit coupled to the chamber, and a second one-way valve coupled to the at least one fluid outlet conduit. The system may also include a first conduit system for combining the pressurized pumping fluid from the chambers and the pumps and conveying the combined fluid to the power generation mechanisms, which may be adapted to utilize the pressurized pumping fluid to generate electrical power. The system may also include a second conduit system for dispersing the fluid from the power generation mechanism to the pumping mechanisms. Each power generation mechanism may also include a supply inlet, and a flow selector may be coupled to the first conduit system and at least one of the supply inlets and configured to control fluid flow to at least one of the power generation mechanisms based on the fluid pressure in the first conduit system.

Various implementations may include one or more features. In certain implementations, for example, electrical power may be generated through using a renewable energy source with little, if any, air pollution. Thus, the energy source may be used almost indefinitely and have a small effect on environmental quality. As another example, the energy source may be found at a variety of locations in a variety of countries. Thus, the power generation may be scaled as needed and may have widespread use. Additionally, using multi-chambered pumps allows more pumping fluid to be pressurized, and, hence, more power produced, for a smaller displacement of the actuating mechanism. This may allow the components to be made smaller and/or work in a more compact space. As a further example, certain implementations allow for the selection between various power generator mechanisms based on the available dynamics of the pumping fluid. This may increase the efficiency of the electrical power produced, as the power generator mechanisms may be operated more of the time within their better performing operational parameters.

The details of one or more implementations are set forth in the accompanying drawings and the description below. Other features will be apparent from the description and drawings, and from the claims.

### DESCRIPTION OF DRAWINGS

FIGS. 1A-B show perspective views of an example wind-powered system for generating electrical power.

FIGS. 2A-B show perspective cut-away views for one example of a pump mechanism for a wind-powered electrical generation system.

FIGS. 3A-B are schematic views of a cylinder for a pump mechanism.

FIGS. 4A-4B are perspective cut-away views of an example valve.

FIG. 5 is a perspective view of another example wind-powered system for generating electrical power.

FIG. 6 is a perspective view of an example wind-powered electrical generation system of FIG. 5.

FIGS. 7A-B are perspective cut-away views of an example flow selector system.

FIG. 8 is a perspective cut-away view of another example wind-powered electrical generation system.

FIG. 9 is a perspective cut-away view of another example wind-powered electrical generation system.

FIG. 10 is a flow diagram illustrating an example process for converting dynamic fluid energy into electrical power.

FIG. 11 is a flow diagram illustrating an example process for regulating power generation mechanisms.

Like reference symbols in the various drawings indicate like elements.

### DETAILED DESCRIPTION

The dynamic energy of a fluid body may be harnessed by various systems, processes, devices, and techniques to produce useful work, such as producing electrical power. In some implementations, for example, systems, processes, devices, and techniques for converting the dynamic energy of a gaseous fluid body into electrical power may include pressurizing a pumping fluid using the flow of the fluid body and using the pressurized pumping fluid to drive a turbine that is coupled to an electrical generator. Other systems, processes, devices, and techniques are possible.

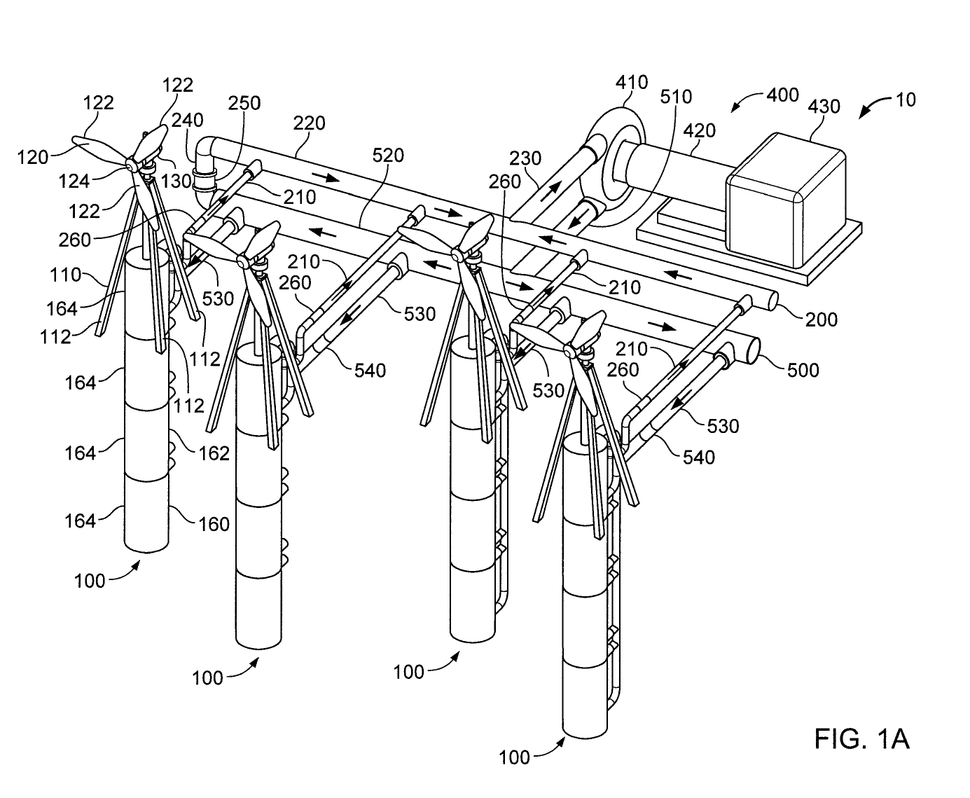

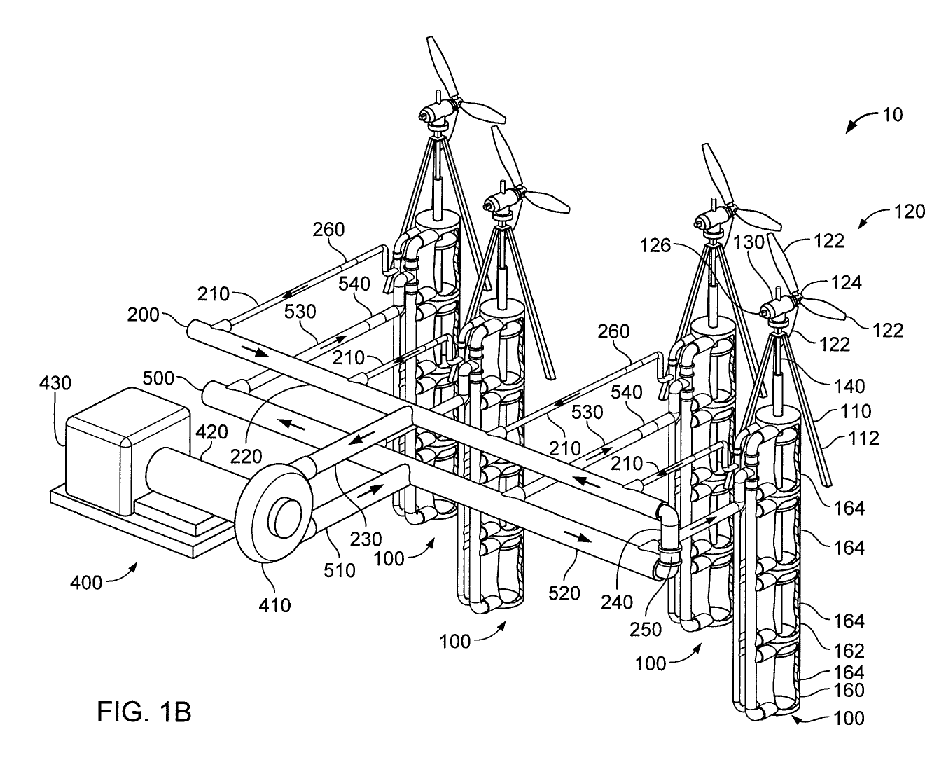

FIGS. 1A-B show an example system 10 for converting dynamic fluid energy into electrical power. In particular, the system 10 can convert gaseous fluid energy (e.g., wind) into electrical power.

The system 10 includes four pumping mechanisms 100, a conduit system 200, an electrical power generator mechanism 400, and a conduit system 500. The system 10 is illustrated as having four pumping mechanisms 100. Having a number of pumping mechanisms 100 may produce an increased and/or more continuous flow of pumping fluid. The pumping fluid may be hydraulic fluid, oil, water, or any other appropriate fluid.

Each pumping mechanism 100 includes a flow-driven moveable member 120 coupled to a pump 160. The moveable member 120 is supported by a support structure 110. As illustrated, support structure 110 includes four legs 112 (only a portion of which are shown to improve clarity), which may be made of metal, wood, composite, or any other appropriate material, but in other implementations, the support structure may have any number of legs, or even no legs. The moveable member 120 may be rotated by a gaseous flow, such as wind, passing around elements 122 of the moveable member 120. In certain implementations, the elements may, for example, be vanes or air foils.

The elements 122 of the moveable member 120 are coupled to a hub 124. The hub 124 is coupled to a shaft 126 that rotates as the moveable member 120 rotates. The shaft 126 is also coupled to a plunger 140 (e.g., a shaft or rod) that drives the pump 160 through a power conversion system 130. As illustrated, the conversion system 130 operates the pump 160 at a desired rate in relation to the moveable member 120. The conversion system 130 may convert the motion of the moveable member 120 (e.g., rotary) into an appropriate motion for the pump 160 (e.g., linear). The conversion system 130 may, for example, include a gear box or reducer.

In certain implementations, for example, first gears attached to the shaft 126 may mate with second gears of the conversion system 130. As the second gears are driven by the first gears, the second gears may actuate connecting rods that are also coupled to the plunger 140 to drive the plunger in response to the second gears. The connecting rods may be pivotably connected to the plunger 140 at or near a first end of the connecting rods. The connecting rods may also be pivotably connected to a radius of the second gears at or near a second end of the connecting rods. Adjusting the size of the first gears and the second gears and/or adjusting the radius at which the connecting rods are connected to the second gears may affect the operational rate of the plunger. For example, for a given rotational speed of the moveable member, increasing the radius of the second gear relative to the first gear may decrease the rotational speed of the second gear. On the other hand, increasing the radius of the first gear relative to the second gear increases the rotational speed of the second gear. The movement of the plunger 140 will change in accordance with the rotational speed of the second gear.

The moveable member 120 may also include an alignment system that aligns the moveable member 120 in a desired orientation. For example, the alignment system may include a pivot that allows the movable number to rotate about a vertical axis. The rotation may, for example, be used to align the moveable member 120 with a predominant fluid flow direction. The moveable member 120 may be moved about the pivot by an alignment device (e.g., from a fin) that is activated by the fluid flow.

The moveable member 120 may also include one or more brakes for slowing and/or stopping a motion of the moveable member. For example, a first brake may be used for stopping and/or slowing a rotational speed of the moveable member 120. A second brake may be used to fix the moveable member 120 into a desired configuration. According to some implementations, the brakes may be separate devices or a single device and may be used to adjust the operation of the moveable member 120, such as during adverse weather conditions, although the brakes may also be used under other conditions.

The pump 160 includes an outer casing 162 through which the plunger 140 extends. The pump 160 also includes a number of chambers 164. A piston in each of the chambers 164 is actuated by the plunger 140.

The pumping mechanisms 100 are coupled to the power generator mechanism 400 through the conduit system 200 and the conduit system 500. The conduit system 200 includes outlet conduits 210, a supply manifold 220, and a supply conduit 230. Similarly, the conduit system 500 includes a return conduit 510, a return manifold 520, and return conduits 530. As shown, the outlet conduits 210 join to the supply manifold 220 to convey pressurized fluid from the pumping mechanisms 100, and the supply manifold 220 joins to the supply conduit 230 to convey the pressurized pumping fluid to the power generator mechanism 400. The supply conduit 230 extends between the supply manifold 220 and the power generator mechanism 400. The return conduit 510 extends between the power generator mechanism 400 and the return manifold 520, which joins the return conduits 530.

A bypass conduit 240 extends between the supply manifold 220 and the return manifold 520 and includes a valve 250 disposed therein. The valve 250 may, for example, be a pressure relief valve. Consequently, if a pressure in the supply manifold 220 exceeds a selected pressure, the valve 250 may open, causing all or a portion of the pumping fluid to be conveyed into the return manifold 520.

Each return conduit 530 includes a valve 540, and each outlet conduit 210 includes a valve 260. Valves 540, 260 may be sensor-actuated valves and may be actuated in response to a signal from a sensor provided at one or more locations of the system 10. For example, a sensor may be located in the pumps 160, the conduit system 200, the power generator mechanism 400, or other locations. The sensors may, for example, activate the valves if contaminants are detected in the pumping fluid. Valves 540, 260 may also be user-actuated valves. A user may, for example, close a set of valves when servicing, repairing, or replacing components of a pumping mechanism 100.

The power generator mechanism 400 includes a mechanical-power converter 410, which is coupled to supply conduit 230 and return conduit 510. The power generator mechanism also includes a power transmission mechanism 420 that couples the mechanical-power converter 410 to an electrical generator 430. The mechanical-power converter 410 may receive the fluid flow from supply conduit 230 and convert it into a mechanical driving force. For instance, the mechanical-power converter 410 can convert the power of the fluid flow into rotary power, and the rotary power can drive the electrical generator 430. In particular implementations, for example, the mechanical-power converter 410 can be a turbine, and the power transmission mechanism 420 can be a shaft.

In one mode of operation, wind causes the moving members 120 to rotate, thereby rotating the shafts 126 associated with the moving members 120. As mentioned above, the moving members 120 may be aligned in a desired direction with an alignment device, for example, to convert the wind energy efficiently. As the shafts 126 rotate, the plungers 140 are cyclically actuated through the conversion systems 130. The plungers 140 actuate the pumps 160, which draw the pumping fluid traveling through the return conduit 510, the return manifold 520, and the return conduits 530 into the chambers of the pumps 160. The pumping fluid is pressurized within the chambers of the pumps 160 and output through the outlet conduits 210, the supply manifold 220, and the supply conduit 230. The pressurized pumping fluid is used to actuate (e.g., spin) the mechanical-power converter 410. The mechanical-power converter 410 actuates the power transmission mechanism 420, which is coupled to the electrical generator 430. The electrical generator 430 converts the mechanical power of the power transmission mechanism 420 into electrical energy.

After the pumping fluid has been utilized to generate electrical power at the generator mechanism 400, the pumping fluid may be returned to the pumping mechanisms 100 through the conduit system 500. The pumping fluid in return conduit 510 may be returned to the pumping mechanisms 100 through positive pressure, negative pressure, and/or gravity. The return of the pumping fluid to the pumping mechanisms 100 through the conduit system 500 may provide a cooling process for the pumping fluid, which may in turn cool the components of pumping mechanisms 100. In some implementations, the cooling may be accomplished by heat exchange with the air around the conduit system 500.

The system 10 has a variety of features. For example, as opposed to generating electrical power through burning fossil fuels (e.g., coal), electrical power may be generated through using a renewable energy source with little, if any, air pollution. Thus, the energy source may be used almost indefinitely and have a small effect on environmental quality. As another example, the energy source may be found at a variety of locations in a variety of countries. Thus, the power generation may be scaled as needed and may have widespread use. As an additional example, using multi-chambered pumps allows more pumping fluid to be pressurized, and, hence, more power produced, for a smaller displacement of the plunger 140. This may allow the plunger 140 and its support and guidance elements to be made smaller.

Other implementations of power generation system 10 may have additional features. For example, conditions that may indicate and/or cause adverse environmental conditions may be monitored and, if detected, contained. For instance, appropriate sensors could detect contamination/leakage of the pumping fluid and use isolation mechanisms (e.g., valves) to stop the flow of pumping fluid to and/or from a fluid pumping mechanism 100 and/or a mechanical-power converter 410. As another example, the pumping fluid could be biodegradable. Thus, the power generation system 10 may provide a minimal impact on the environment if a problem does arise.

Although four pumping mechanisms 100 are illustrated, other implementations may include fewer or additional pumping mechanisms 100. Additionally, the pumping mechanisms 100 may be joined with one or more generator mechanisms 400 via power transmission mechanisms 420 and corresponding mechanical-power converters 410. Moreover, in certain implementations, two or more pumping mechanisms 100 may be used in a many-to-one correspondence with a mechanical-power converter 410, as explained above. In particular implementations, for instance, a power transmission mechanism 420 may be driven by only one mechanical power converter 410, which may be driven by one or more pumping mechanisms 100.

According to certain implementations, the power generator mechanism 400 may include a plurality of mechanical-power converters 410, each corresponding to one or a group of pumping mechanisms 100. The pumping fluid from each pumping mechanism 100 or group of pumping mechanisms 100 may be directed to a corresponding mechanical-power converter 410 through a corresponding conduit system. The mechanical-power converters 410 may be actuatable by the pressurized pumping fluid and coupled to one or more power transmission mechanisms 420. Therefore, as the pressurized pumping fluid actuates a mechanical-power converter 410, a power transmission mechanism 420 is also actuated. The actuation of a power transmission mechanism 420 consequently drives an electrical generator 430 to generate electrical power.

As shown, the outlet conduit 210 has a smaller diameter than the return conduit 530 because the pumping fluid passing through the outlet conduit 210 may have a higher pressure than the pumping fluid passing through the return conduit 530. However, the conduits 530, 210 may be any size. For example, the outlet conduit 210 may be larger than the return conduit 530 or vice versa. The conduits 530, 210 may also be the same size in certain implementations.

The movable members 120, the pumps 160, the return conduits 530, the outlet conduits 210, the supply conduit 230, the return conduit 510, the supply manifold 220, the return manifold 520, the mechanical-power converter 410, the power transmission mechanism 420, and the electrical generator 430, as well as other components of the system 10, may be sized according to an intended application, taking into consideration factors such as an amount of power to be generated, the anticipated flow speed, etc. Certain implementations may include a housing having an inner chamber. The inner chamber may act as a fluid reservoir from which the pumping fluid may be drawn into the pump. For example, the reservoir may store several cycles worth of pumping fluid for one or more pumps 160. In particular implementations, a pump 160 may also be located in the housing, or even in the inner chamber.

Various components of the system 10 may also be configured in other manners. For example, although shown as being composed of our legs 112, the support structure 110 may have any number of legs. Moreover, the support structure may have bracing between the legs. As another example, although the movable members 120 are shown as having three elements 122, an appropriate movable member may have any number of elements. Moreover, the elements may be shaped like fins, blades, or appropriate shapes and/or have bracing therebetween as appropriate.

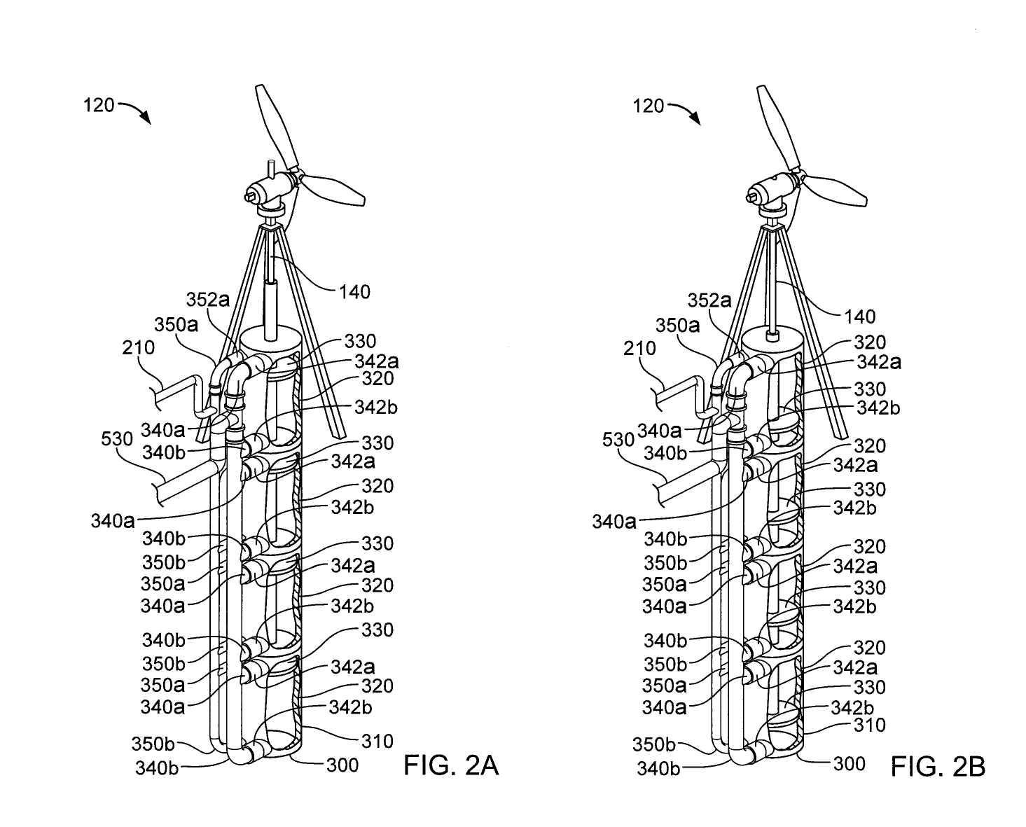

FIGS. 2A-B illustrate one example a multi-chambered pump 300 for system 10. As illustrated, the pump 300 includes a cylinder 310 that is divided into a number of chambers 320. Each chamber 320 includes a piston 330 disposed in the cylinder 310 and coupled to the plunger 140.

Each chamber 320 also includes a first inlet conduit 340a attached to one portion of the chamber for conducting the pumping fluid into the cylinder 310 of the pump 300, and a second inlet conduit 340b attached to a second portion of the chamber for conducting the pumping fluid into the cylinder 310. A first outlet conduit 350a is also attached to the first portion for conducting the pumping fluid out of the cylinder 310, and a second outlet conduit 350b is attached to the second portion for conducting the pumping fluid out of the cylinder 310. The first and second inlet conduits 340a, 340b and the first and second outlet conduits 350a, 350b provide for fluid communication with an interior of the cylinder 310 of the pump 300. Thus, the pumping fluid is able to flow through the conduits 340-350 and into or out of the interior of the cylinder 310. The flow is controlled by a set of valves, which are described below.

Coupled to the inlet conduits 340a, 340b of each chamber 320 is the return conduit 530. The return conduit 530 couples to both the first and second inlet conduits 340a, 340b so that pumping fluid may be drawn through both of the inlet conduits from the return conduit. Each inlet conduit 340a includes a valve 342a (only one of which can be seen), and each inlet conduit 340b includes a valve 342b to control the flow through the inlet conduits. In particular implementations, the valves 342a, 342b may only permit fluid to flow in the direction of the pump 300. The valves 342a, 342b may, for example, be check valves.

Coupled to the outlet conduits 350a, 350b of each chamber 320 is the outlet conduit 210. The outlet conduit 210 couples to the outlet conduits 350a, 350b so that pressurized pumping fluid from the pump 300 may be conveyed through the inlet conduits to the outlet conduit 210. Each outlet conduit 350a includes a valve 352a, and each outlet conduit 350b includes a valve 352b. In particular implementations, the valves 352a, 352b may only permit fluid to flow away from the pump 160. The valves 352a, 352b may, for example, be check valves.

In one mode of operation, as the pistons 330 are moved toward the moveable member 120, the valves 352a allow fluid to exit the chambers 320 of the pump 300 and enter the outlet conduit 210. At the same time, the valves 352b prevent the exiting fluid from re-entering the chambers. Additionally, the valves 342b allow fluid to flow into the chambers 320 of the pump 300 from the return conduit 530, and the valves 342a prevent the exiting fluid from entering the return conduit 530. As the pistons 330 are moved away from the moveable member 120, however, the valves 352b allow fluid to exit the chambers 320 of the pump 160 and enter the outlet conduit 210, and the valves 352a prevent the exiting fluid from re-entering the pump 160. Additionally, the valves 342a allow fluid to flow into the pump chambers 320 of the 160 from the return conduit 530, and the valves 342b prevent the exiting fluid from entering the return conduit 530.

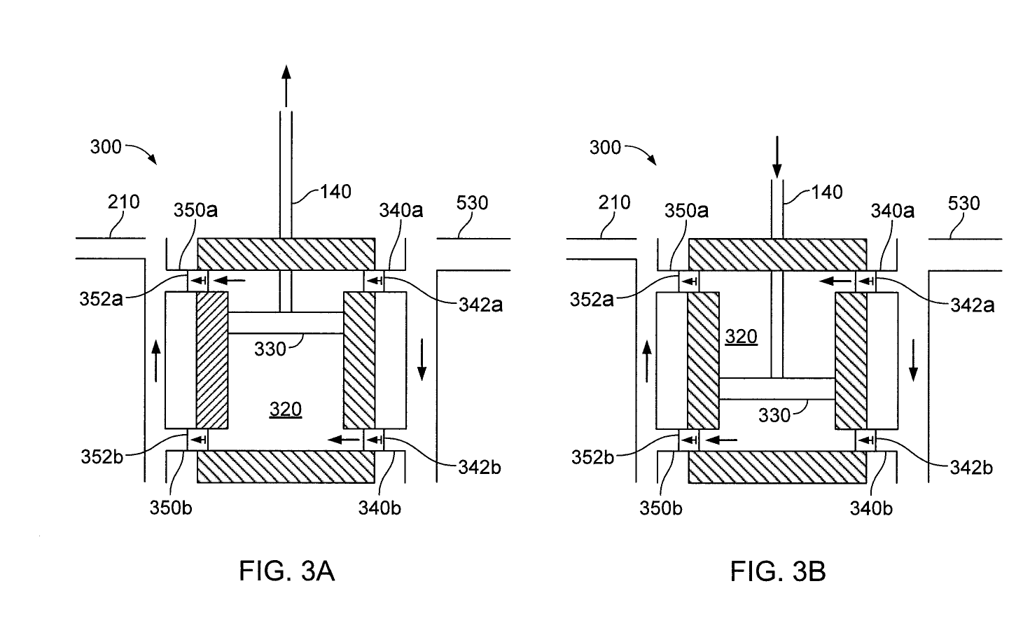

The operation of one of the chambers 330 320 of the pump 300 is also described with reference to FIGS. 3A-B. In operation, the plunger 140 reciprocates the piston 330 between a position near a first end and a second end of the chamber 320. As the piston 330 moves towards the first end (see FIG. 3A), the pressure below the piston 330 is reduced. This lower pressure allows the valve 342b to open, drawing the pumping fluid from the return conduit 530 and into the chamber 320, through the inlet conduit 340b and the valve 342b. At the same time, the pressure above the piston 330 increases, forcing the pumping fluid out through the outlet conduit 350a and the valve 352a and into the outlet conduit 210. The pumping fluid is prevented from being forced out of the inlet conduit 340a by the valve 342a and through the outlet conduit 350b by the valve 352b.

As the plunger 140 moves the piston 330 moves towards the second portion (see FIG. 3B), the pressure above the piston 330 decreases, allowing the valve 342a to open, drawing the pumping fluid from the return conduit 530 and into the chamber 320, through the inlet conduit 340a. At the same time, the pumping fluid below the piston 330 is forced out through the outlet conduit 350b and the valve 352b and into the outlet conduit 210. The valve 342b prevents the pumping fluid from flowing out of the chamber 320 through the inlet conduit 340b, and the valve 352a prevents pumping fluid from flowing through the outlet conduit 350a and into the chamber.

As just discussed, pumping fluid may be simultaneously drawn into and forced out of the pump 300 during both the upward and downward stroke of the piston 330. Thus, in this implementation, the example pump 300 has dual-action functionality. In other implementations, the pump 300 may, for example, have a single-action functionality. That is, the pump 300 may intake pumping fluid during one of an upwards or downwards motion of the plunger 140 and may output pumping fluid during the other of the upwards or downwards motion. Accordingly, such an implementation may only require a single inlet conduit and a single outlet conduit. Such inlet and outlet conduits may both be attached to a first portion or a second portion of a pump chamber or may be attached to alternate portions of a chamber. In these latter implementations, a valve may included in the piston to allow fluid to flow from the back side of the piston to the front side during a return stroke.

In certain implementations, a valve may allow the pumping fluid to be recirculated to the pump 300. For example, a valve may be coupled between the supply conduit 210 and the return conduit 530. If a detrimental condition is detected (e.g., contamination), the valve may be opened to allow the pressurized pumping fluid to recirculate to the pump 300. Additionally, valves may be actuated to prevent fluid from entering or leaving the vicinity of the pump 300 Thus, the pumping mechanism 300 may continue to operate without the contaminated fluid reaching the rest of the system.

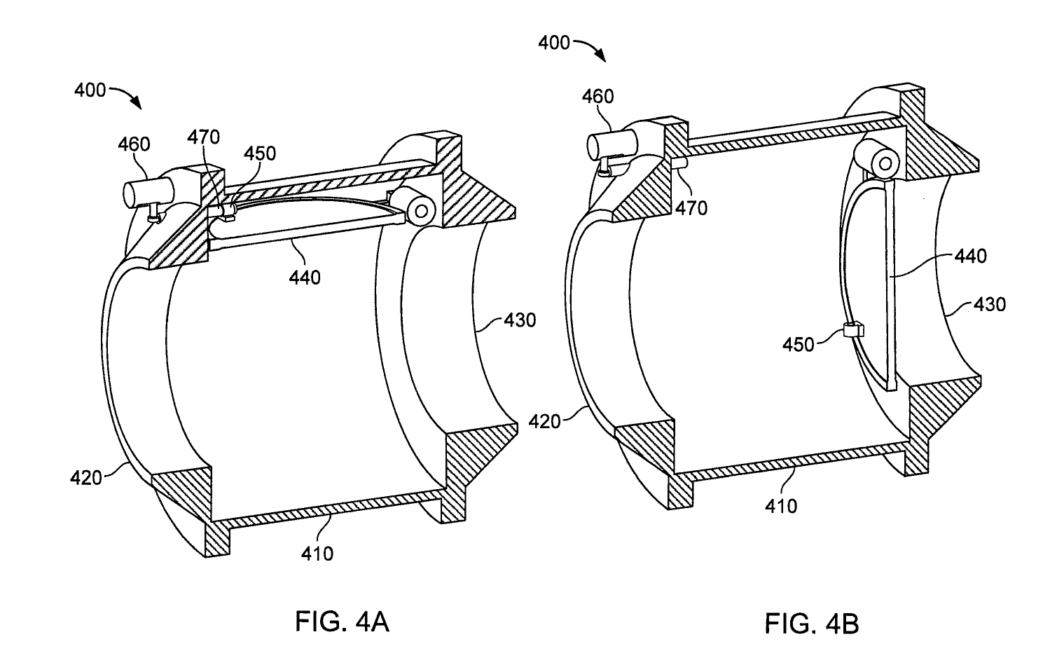

FIGS. 4A-4B show an example valve 400 that may be similar to the valves 260, 540. The valve 400 includes a body 410 having first and second openings 420, 430 and a gate 440 pivotable within the body 410. During normal operations, the gate 440 may be fixed in an open position providing open communication between the first and second openings 420, 430. If a selected condition occurs, such as if contamination or a leak is detected, the gate 440 may be released and pivot downwardly into a closed position, preventing fluid from passing through the valve 400. According to the example valve shown in FIGS. 4A-B, the gate 440 includes an appendage 450 extending therefrom. Thus, when a condition is detected, an actuator 460 retracts a pin 470 extending through an opening formed in the appendage 450, and the gate 440 pivots downwardly, sealing the valve 400. The valve 400 may also be user-actuated.

A system 10 may include additional and/or different valves. For example, the additional and/or other valves may be manually actuated, e.g., actuated via a hand-crank. The valves included in the system, including the valves 260, 540 may be operable to stop flow of the pumping fluid through the return conduits 210 and the outlet conduits 530 when a selected condition is detected, actuated in order to isolate the associated pump, or for some other reason. For example, a pump may be removable for maintenance, repair, and/or replacement. Accordingly, the output conduit 210 and return conduit 530 may include one or more shut-off valves. The shut-off valves may be similar to the sensor actuated valves 260, 540. The shut-off valves may be disposed on opposite sides of a disconnect, which may be a pair of flanged ends abutting one another or any other mechanism for detaching one end of a conduit from another end. When disconnecting the pump from the output conduit 210 and the return conduit 530, the shut-off valves may be closed and the disconnect uncoupled. Consequently, pumping fluid is prevented from entering the pump from the return conduit 530 or leaving the pump for the supply conduit 210.

As mentioned above, a fluid energy system may include one or more sensors for detecting an operating condition of the system. Operating conditions may include a flow rate within the system, a quality of the pumping fluid (e.g., the amount of a contaminant in the pumping fluid), a pumping speed of the pump, a rotational speed of the moveable member, an output of the power generator mechanism, or some other aspect of the system desired to be measured. Contaminants may include dirt, water, or chemical impurities, for example. The sensor may be communicably coupled to the valve 260 and/or the valve 540, or some other valve(s) within the system. If a predetermined operating condition is detected, the sensor may send a signal to one or more valves, such as valves 260, 540, adjusting a position thereof. For example, the sensor may command the valves 260, 540 to close or otherwise redirect a flow of the pumping fluid. Consequently, when contamination is detected, the pumped fluid may be prevented from being conveyed from and/or to the power generator mechanism.

Power to a sensor, one or more sensor actuated valves of the system, or other devices may be provided, for example, by a power line, battery, or any other power source, such as solar power. Further, a sensor may be adapted to provide an alarm signal when the predetermined condition is detected. For example, a sensor may send the alarm signal to one or more lights disposed on the pumping mechanisms. Further, the alarm signal may be transmitted via a wired or wireless connection to a remote user to indicate the occurrence of the predetermined condition.

As indicated above, each pumping mechanism may have one or more associated flow rate sensors. A flow rate sensor may be provided on one or more of the return conduits 530 and the outlet conduits 210, the supply manifold 220, the return manifold 520, the supply conduit 230, and the return conduit 510. The flow rate sensor may measure a flow rate of the pumping fluid passing through a conduit of the system. According to some implementations, the flow rate sensors may transmit a signal indicating the measured flow rate of the pumping fluid to a controller. The flow rate measurements may be compared, and an alarm may be triggered if a difference between the flow rate measurements exceeds a selected amount. For example, the flow rate sensors may transmit the flow rate measurements to a central controller that may compare the measurement values and determine if a difference, if any, exceeds a predetermined amount. Such a difference may, for example, indicate a leak. Further, the controller may open or close one or more of the valves of the system. For example, the controller may open or close one or more of the valves 260, 540 in order to adjust an amount of the pumping fluid conveyed to or from the pumping mechanisms or stop flow of the pumping fluid to or from the pumping mechanisms or both. The central controller may be a human user or may be a mechanical or electronic device operable to receive, analyze, and transmit signals.

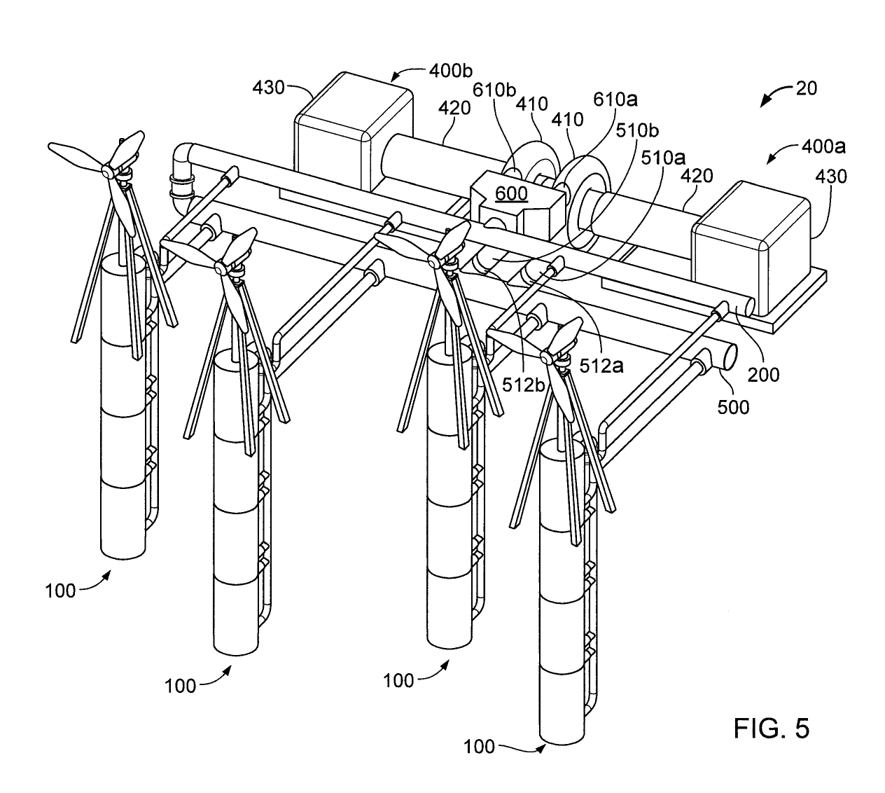

FIG. 5 illustrates an example wind-powered system 20 for generating electrical power. Similar to system 10, system 20 includes several pumping mechanisms 100, a conduit system 200, and a conduit system 500. The system 20 is shown with four pumping mechanisms 100, but may generally include one or more pumping mechanisms 100, although having several pumping mechanisms 100 may produce an increased and/or more continuous flow of pumping fluid.

The system 20 also includes two electrical power generator mechanisms 400. Thus, the pumping mechanisms 100 may be used to drive multiple power generator mechanisms 400. The power generator mechanisms 400 are coupled to the pumping mechanisms 100 through supply conduit system 200 and a flow selector 600. The flow selector 600 is operable to supply flow to one or both of the power generator mechanisms depending on the flow supplied by the pumping mechanisms 100. The flow selector 600 may operate by mechanical, electronic, or other techniques. For example, in certain implementations, the flow selector 600 may be a pressure-activated gate device. The flow selector 600 is coupled to the inlet of the mechanical-power converter 410a of the power generator mechanism 400a by an outlet conduit 610a and to the inlet of the mechanical-power converter 410b of the power generator mechanism 400b by an outlet conduit 610b. The mechanical-power converters 410 are coupled to the pumping mechanisms 100 through return conduits 510 of conduit system 500. The return conduits 510 contain valves 512 to prevent flow of the pumping fluid toward the mechanical-power converters 410.

In one mode of operation, when the pumping mechanisms 100 produces pressurized pumping fluid at a low rate, the flow selector 600 diverts the flow to one of the power generator mechanisms 400 and not the other. This may allow the supplied power generator mechanism 400 to produce electrical power. As the flow rate of the pumping fluid increases, the flow selector 600 may begin to divert some flow to the other power generator mechanism 400. For example, once the first power generator mechanism 400 begins to operate at a given efficiency, flow may start to be diverted to the other power generator mechanism 400. Thus, one of the power generator mechanisms 400 may be producing a high amount of power, at least for its rating, and the other power generator mechanism may be not be producing a high amount of power, at least for its rating. As the flow rate increases further, the flow selector 600 may supply pressurized fluid to both power generator mechanisms 400 so that both run efficiently. The reverse may also take place as the flow rate produced by the pumping mechanisms decreases.

In certain implementations, the power generator mechanisms 400 may have different power production ratings. Thus, the flow selector 600 may divert flow to the power generator mechanisms depending on the flow rate and the power generator mechanisms' 400 ratings. For example, the flow selector 600 may divert flow to the lower rated power generator mechanism 400 when the flow rate is low, the higher rated power generator mechanism 400 when the flow rate is medium, and both power generator mechanisms when the flow rate is high. Additionally, the flow diverted to each power generator mechanism 400 need not be equal.

System 20 has a variety of features. For example, by being able to select between the power generator mechanisms 400, the system may utilize a larger range of wind velocities. Moreover, this may increase the efficiency of the power produced, as the power generator mechanisms 400 may be operated more of the time within their better performing operational parameters.

In other implementations, system 20 may have fewer, additional, and/or a different arrangement of components. For example, system 20 may include more than two power generator mechanisms 400. Thus, the flow selector 600 may be able to divide the flow in various ratios. As another example, system 20 may not have multi-chambered pumps. That is, the flow selector 600 could work with single-chambered or multi-chambered pumps. Additionally, flow selector 600 may work with various types of pumps, whether wind-driven or not.

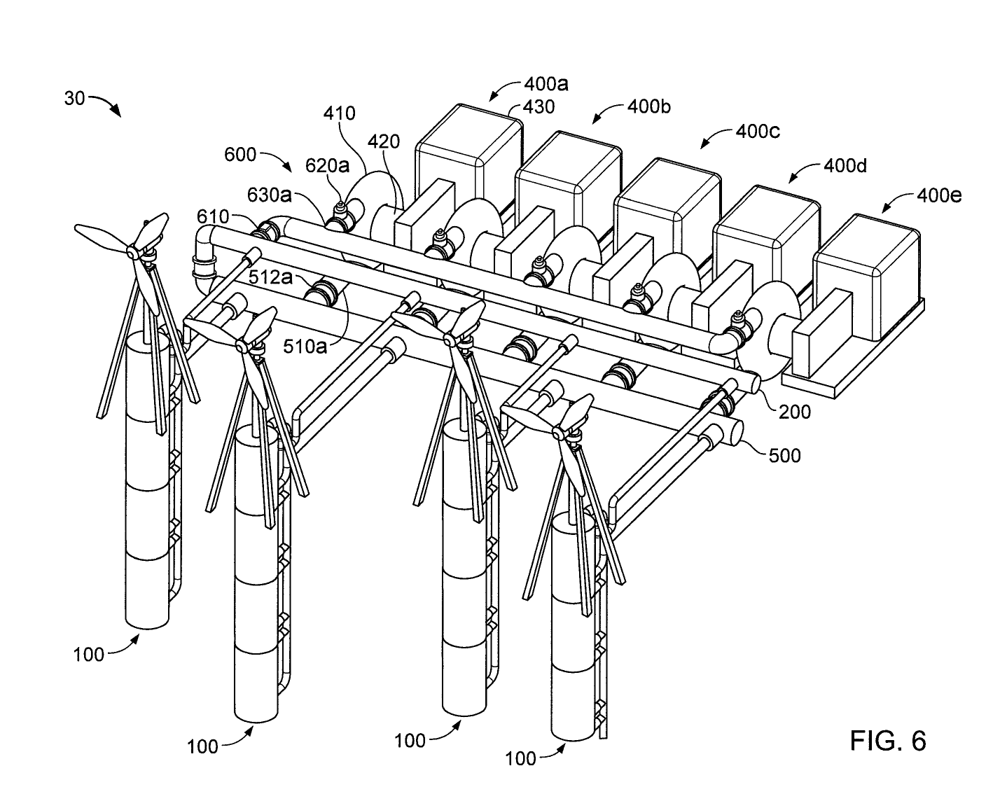

FIG. 6 illustrates an example wind-powered system 30 implementing a flow selector 600. Similar to system 20, system 30 includes a plurality of pumping mechanisms 100, a conduit system 200, and a conduit system 500. Additionally, the system 10 is shown with four pumping mechanisms 100, but may include one or more pumping mechanisms 100.

System 30 also includes five electrical power generator mechanisms 400, although any number could be used. Thus, the pumping mechanisms 100 may be used to drive multiple power generator mechanisms 400. The power generator mechanisms 400 are coupled to the pumping mechanisms 100 through conduit system 200 and a flow selector 600. The flow selector 600 is operable to supply flow to one or more of the power generator mechanisms 400 depending on the flow supplied by the pumping mechanisms 100. In this implementation, the flow selector 600 includes an electronic pressure gauge 610 coupled to the conduit system 200. The electronic pressure gauge 610 provides commands to actuators 620 for the valves 630. The pressure gauge may, for example, include a controller to determine the appropriate commands. A controller may, for example, include a programmed processor (e.g., a microprocessor). The program may be part of the processor or stored in memory (e.g., RAM, ROM, PROM, or EEPROM). The commands may be relayed by wireline (e.g., 4-20 ma) or wireless techniques (e.g., IEEE 802.11). Each actuator 620 controls an associated valve 630, causing it to open and shut, and, hence, supply flow to the associated mechanical-power converter. The mechanical-power converters 410 are coupled to the pumping mechanisms 100 through return conduits 510. The return conduits contain valves 512 to prevent flow of the pumping fluid toward the mechanical-power converters 410.

In one mode of operation, when the pumping mechanisms 100 produce pressurized pumping fluid at a low rate, the pressure sensor 610 senses the pressure of the flow and generates commands instructing one of the actuators 620 to open an associated valve 630 and for the other actuators 620 to close their valves. Thus, flow is diverted to one of the power generator mechanisms 400 and not the others. This may allow the supplied power generator mechanism 400 to produce electrical power. As the flow rate of the pumping fluid increases, the flow selector 600 may begin to divert some flow to one or more of the other power generator mechanisms 400. For example, once the first supplied power generator mechanism 400 begins to operate at a given efficiency, flow may start to be diverted to a second power generator mechanism 400. Thus, one of the power generator mechanisms 400 may be producing a high amount of power, at least for its rating, and the other power generator mechanism may be not be producing a high amount of power, at least for its rating. As the flow rate increases further, the flow selector 600 may supply pressurized fluid to both power generator mechanisms 400 so that both run efficiently. The flow selector 600 may continue to actuate more valves as the flow rate increase until all of the valves are open. As the flow rate decreases, the flow may be diverted from power generator mechanisms 400.

In certain implementations, the power generator mechanisms 400 may have different power production ratings. Thus, the flow selector 600 may divert flow to the power generator mechanisms 400 depending on the flow rate and the power generator mechanisms' 400 rating. For example, the flow selector 600 may divert flow to the lowest rated power generator mechanism 400 when the flow rate is low, a higher rated power generator mechanism 400 when the flow rate is medium, a combination of power generator mechanisms 400 when the flow rate is relatively high, and all of the power generator mechanisms when the flow rate is high. Additionally, the flow diverted to each power generator mechanism 400 need not be equal.

System 30 has a variety of features. Similar to the system 20, by being able to select between the power generator mechanisms 400, the system 30 may utilize a larger range of wind velocities. Moreover, this may increase the efficiency of the power produced, as the power generator mechanisms 400 may be operated more of the time within their better performing operational parameters. Additionally, by being able to select between a large number of power generator mechanisms, the system 30 may be able to provide a large range of flow rates that provide efficient operations of the power generator mechanisms 400.

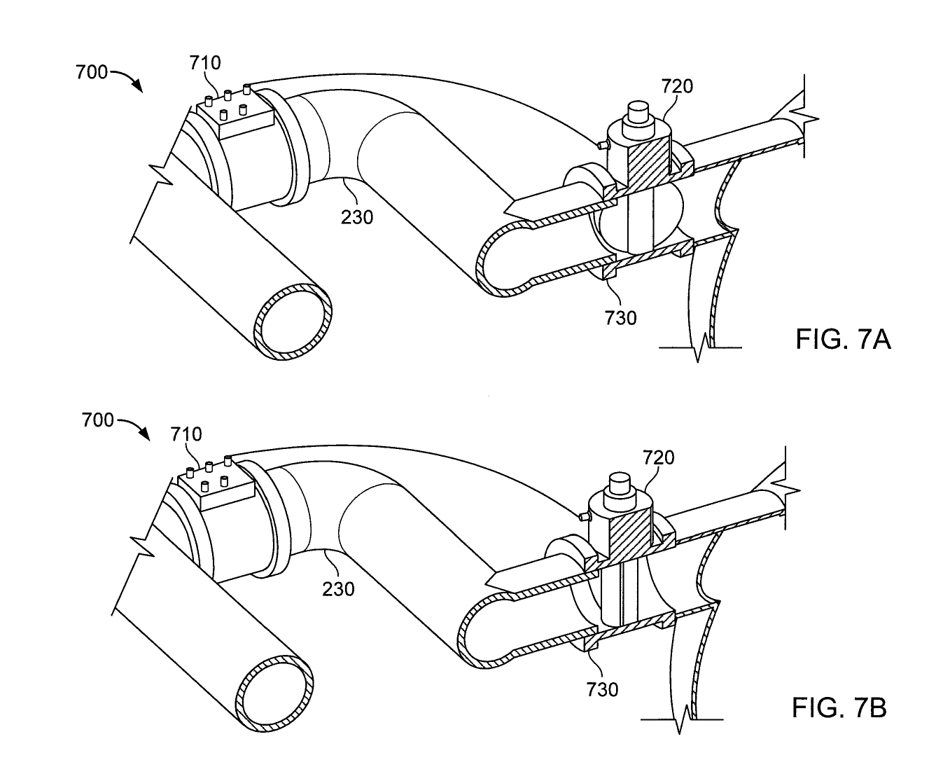

FIGS. 7A-B illustrate one implementation of a flow selector 700 for a electrical power generation system. In this implementation, the flow selector 700 includes an electronic pressure gauge 710 coupled to a supply conduit 230. The electronic pressure gauge 710 provides commands to actuators 720 for valves 730 (only one set of which is shown). The commands are relayed by wireline techniques (e.g., 4-20 ma). Each actuator 720 controls the associated valve 730, causing it to open (FIG. 7A) and shut (FIG. 7B), and, hence, supply flow to the associated mechanical-power converter 410.

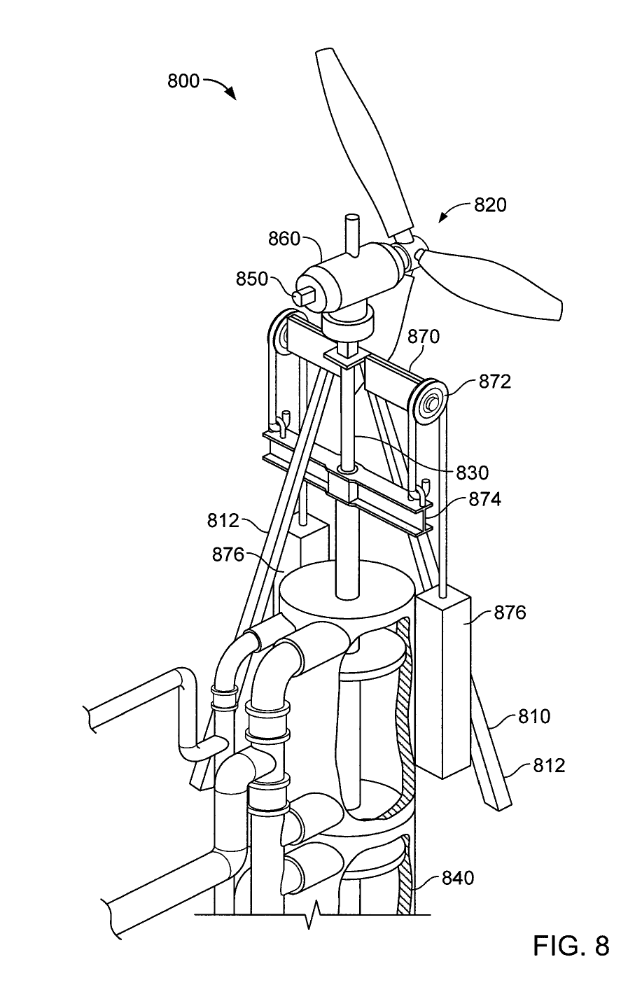

FIG. 8 illustrates an example pumping mechanism 800 for a wind-powered electrical generation system. In this implantation, the pumping mechanism 800 includes a flow-driven moveable member 820 coupled to a pump 840. The moveable member 820 is be supported by a support structure 810, which includes multiple legs 812 (only a portion of which are shown to improve clarity). The moveable member 820 may be rotated by a gaseous flow, such as wind. The moveable member 820 is coupled to a shaft 850 that rotates as the moveable member 820 rotates. The shaft 850 is also coupled a plunger 830 that actuates the pump 840 through a power conversion system 860. As illustrated, the conversion system 860 operates the plunger 830 and, hence, the pump 840 at a desired rate in relation to the moveable member 820. The conversion system 860 converts the motion of the moveable member 820 (e.g., rotary) into an appropriate motion for the pump 840 (e.g., linear).

The pumping mechanism 800 also includes an actuation assistance system 870. The actuation assistance system 870 includes a pulley system 872, a force application member 874, and counterweights 876. The pulley system 872 is coupled to the support structure 870, and the force application member 874 is coupled to the plunger 830. The counterweights 876 are coupled to the force application system 874 by tension members (e.g., cables). Although two pulleys are shown for the pulley system 872, any number of pulleys may be used in other applications.

In operation, as the plunger 830 is driven down by the rotation of moveable member 820, the force application member 874 is also driven down, which lifts counterweights 876. Then, when the plunger starts to be driven upward by further rotation of the moveable member 820, the counterweights are able to assist with returning the plunger to its starting position.

The actuation assistance system 800 can assist the actuation of the pump 840 by offsetting the different forces experienced by the plunger 830 in its downward and upward movements. For instance, during the downward movement, gravity is acting in a positive manner on the piston arrangement and/or pumping fluid in the pump 800. However, during an upward movement, gravity is retarding the movement of the plunger 830. The actuation assistance system 800 can then provide assistance during the upward movement by allowing counterweight 872 to fall. Thus, the actuation assistance system 800 can smooth out the operation of the pumping mechanism 800.

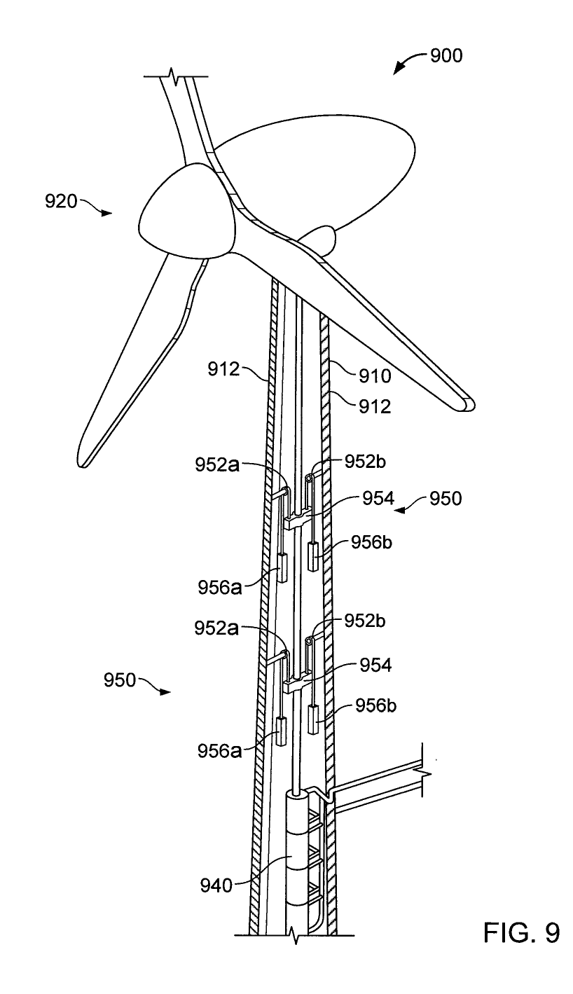

FIG. 9 illustrates another example pumping mechanism 900 for a wind-powered electrical generation system. In this implantation, the pumping mechanism 900 includes a flow-driven moveable member 920 coupled to a pump 940. The moveable member 920 is be supported by a support structure 910, which includes multiple legs 912 (only a portion of which are shown to improve clarity). The moveable member 920 may be rotated by a gaseous flow, such as wind. Rotation of the moveable member 920 drives a plunger 930, which actuates the pump 940.

The pumping mechanism 900 also includes two actuation assistance systems 950. Each actuation assistance system 950 includes a pulley system 952, a force application member 954, and counterweight 956. The pulley system 952 is coupled to the support structure 910, and the force application member 954 is coupled to the plunger 950. The counterweights 956 are coupled to the corresponding force application system 954 by tension members.

In operation, as the plunger 930 is driven down by the rotation of moveable member 920, the force application member 954 is also driven down, which lifts counterweights 956. Then, when the plunger 930 starts to be driven upward by further rotation of the moveable member 920, the counterweights are able to assist with returning the plunger 930 to its staring position.

Similar to the actuation assistance system 800, system 900 can assist the actuation of the pump by offsetting the different forces experienced by the plunger 930 in its downward and upward movements. Thus, the actuation assistance system 900 can smooth out the operation of the pumping mechanism 900.

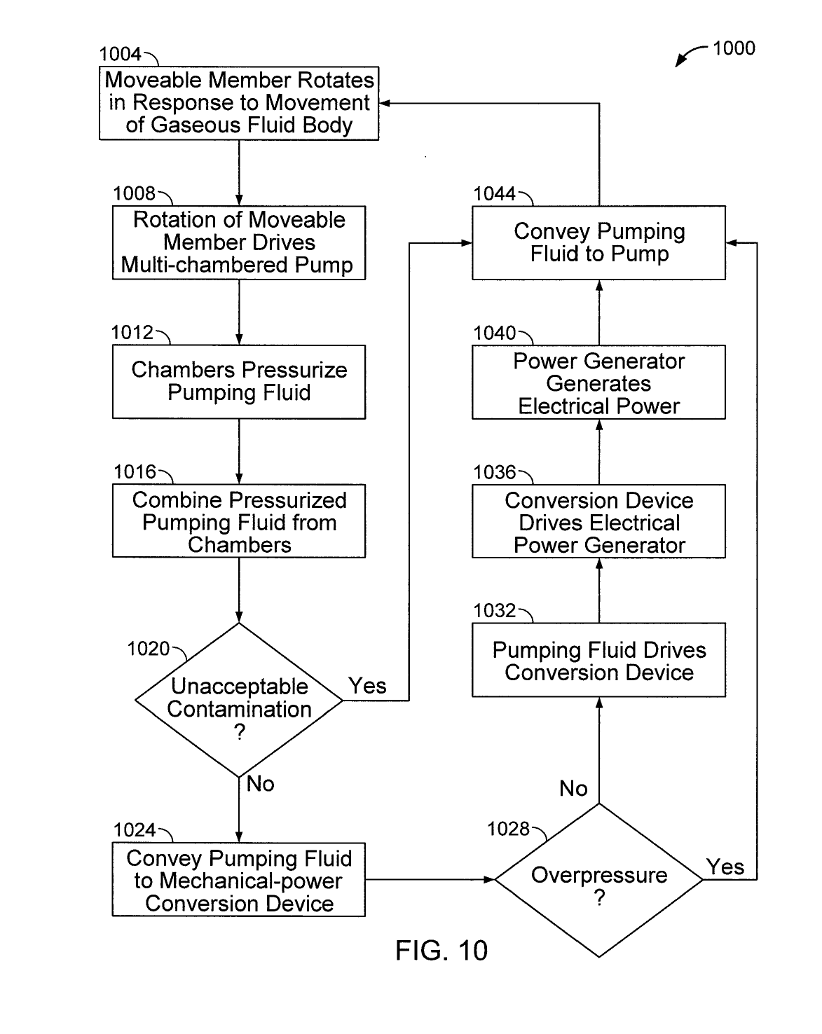

FIG. 10 illustrates an example process 1000 for converting dynamic fluid energy. Process 1000 calls for a moveable member rotating in response to movement of a gaseous fluid body (operation 1004). For example, a wind current may rotate a wind turbine within a wind flow. Process 1000 also calls for driving a multi-chambered pump with the rotation of the moveable member (operation 1008). The pump may, for example, include a number of chambers that operate through a double-action sequence. The moveable member and the pump may be coupled together through a power transmission mechanism, which may produce a cyclical motion for the pump. For example, pistons may be made to move within each chamber to pressurize a portion of the fluid. The chambers of the pump pressurize a pumping fluid in response to being driven (operation 1012), and the pressurized fluid from the chambers is combined (operation 1016).

The pumping fluid may be analyzed to determine whether it is unacceptably contaminated (operation 1020). A sensor may, for example, determine whether too much particulate matter is present in the pumping fluid, which may degrade mechanical components. If the level of contamination is not unacceptable, the pumping fluid is conveyed to a mechanical-power conversion device (operation 1024). The pressurized pumping fluid may, for example, form a flow that is conveyed by a conduit system.

While being conveyed to the conversion device, a determination is made regarding whether the pressure of the pumping fluid is too high (operation 1028). A sensor may, for example, determine whether the pressure of the pumping fluid is to high. If the pressure of the pumping fluid is not too high, the pumping fluid arrives at the conversion device and drives it (operation 1032). The conversion device may, for example, be a turbine, and the pumping fluid may flow around the turbine's vanes to drive the turbine.

The conversion device drives an electrical power generator (operation 1036). The conversion device may, for example, be coupled to the power generator through the use of a rotary shaft. The power generator generates electrical power in response to being driven by the conversion device (operation 1040).

The pumping fluid is conveyed back to the pump from the conversion device (operation 1044). The pumping fluid may then again be pressurized by another movement of the fluid body.

If, however, an unacceptable level of contamination is detected in the pumping fluid (operation 1020), the pumping fluid may be conveyed back to the pump (operation 1044). Thus, contaminated pumping fluid may prevented from reaching the conduit system, the conversion device, and/or other components of the power generation system.

Additionally, if too much pressure is detected in the pumping fluid (operation 1028), the pumping fluid may be conveyed back to the pump (operation 1044). Thus, over-pressurized pumping fluid may be prevented from reaching the conversion device.

Although FIG. 10 illustrates one implementation of a process for converting dynamic fluid energy, other implementations may include fewer, additional, and/or a different arrangement of operations. For example, a process for converting dynamic fluid energy may include a number of moveable members that are exposed to the flow to actuate a number of pumps. The pressurized fluid from the pumps may be used individually or in combination to generate electricity. Additionally, two or more of a process's operations may be performed in a contemporaneous or simultaneous manner. In particular modes of operation, for example, all of a processes operations may occur at the same time. Moreover, a process's operations may be performed continuously or intermittently for any period of time. As another example, checking for contamination and/or overpressure may not be performed.

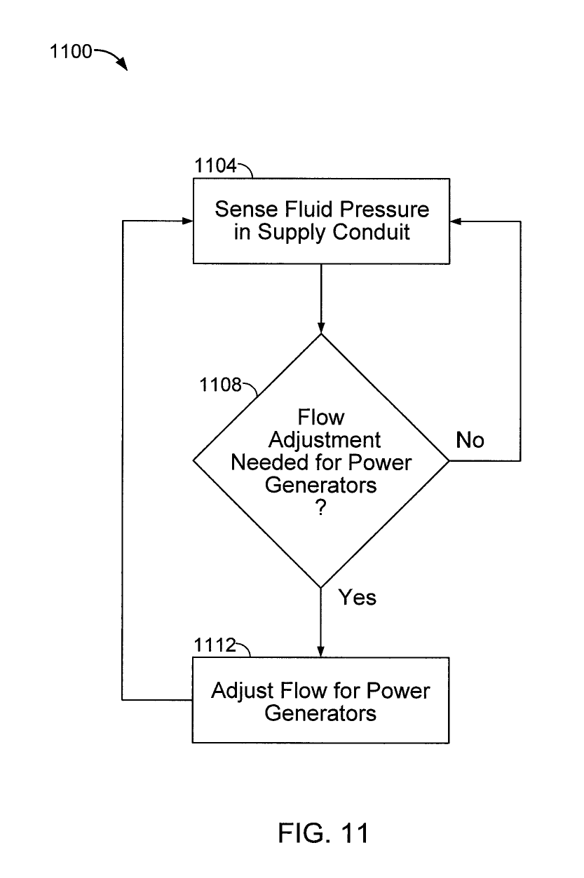

FIG. 11 illustrates an example process 1100 for controlling electrical power generator mechanisms. Process 1100 begins with sensing fluid pressure in a supply conduit (operation 1104). The pressure may, for example, have been generated by one or more pumping mechanisms having one or more chambers. Based on the pressure in the supply conduit, a determination is made as to whether a flow adjustment should be made for the power generators (operation 1108). The determination may, for example, be made by a mechanical or logical device. For instance, if there is not enough flow to operate two power generators efficiently, the flow to one of the power generators may be restricted to increase the flow to the other power generator. If no flow adjustment should be made, the process 1100 calls for continuing to sense the pressure in the supply conduit (operation 1104).

If, however, a flow adjustment should be made, the process 1100 calls for adjusting the flow for the power generators (operations 1112). For example, one or more valves could be opened or closed to increase or decrease flow to one or more power generators. Once the flow adjustment has occurred, the process 1100 calls for continuing the sense the pressure in the supply conduit (operation 1104).

Although FIG. 11 illustrates one implementation of a process for controlling electrical power generation mechanisms, other processes for controlling power generation mechanisms may include fewer, additional, and/or a different arrangement of operations. For example, a control process may include receiving feedback regarding the flow supplied to the power generation mechanisms. The process may then further adjust the flow. As another example, a control process may not determine whether a flow adjustment is needed. For instance, a mechanical flow controller may simply respond to the sensed fluid pressure. As a further example, there may be delays between using the fluid pressure to allow transients to settle.

A number of implementations have been described, and several others have been mentioned or suggested. Additionally, various additions, deletions, substitutions, and/or modifications to these implementations will readily be suggested to those skilled in the art while still achieving dynamic fluid energy conversion. Thus, the scope of protectable subject matter should be judged based on the claims, which may encompass one or more aspects of one or more implementations.

What is claimed is:

1. A system for utilizing movements of a gaseous fluid body to generate electrical power, the system comprising:
a first pumping mechanism comprising:
a flow-driven moveable member adapted to rotate in response to movement of a gaseous fluid body, and
a pump coupled to the moveable member and adapted to pressurize a pumping fluid in response to motion of the moveable member, the pump comprising:
a multi-chambered cylinder;
a plunger extending through the multi-chambered cylinder and driven by motion of the moveable member; and
a plurality of pistons coupled to the plunger, each piston disposed in a separate chamber of the multi-chambered cylinder, the plurality of pistons adapted to pressurize a pumping fluid in response to motion of the moveable member; and
an electrical power generation mechanism adapted to utilize the pressurized pumping fluid to generate electrical power.

2. The system of claim 1, further comprising a conduit system for combining the pressurized pumping fluid from the chambers and conveying the combined fluid to the power generation mechanism.

3. The system of claim 1, further comprising a housing, the housing comprising an inner chamber from which the pump draws the fluid to be pressurized.

4. The system of claim 3, wherein the chamber serves as a reservoir for multiple pumping cycles worth of the pumping fluid.

5. The system of claim 1, wherein the moveable member comprises:
a hub to which radially extending elements are coupled; and
an alignment system adapted to align the member with fluid body movements.

6. The system of claim 1, further comprising:
at least one fluid inlet conduit coupled to one of the chambers;
a first one-way valve coupled to the at least one fluid inlet conduit;
at least one fluid outlet conduit coupled to the chamber; and
a second one-way valve coupled to the at least one fluid outlet conduit.

7. The system of claim 1, further comprising a power conversion mechanism adapted to convey power from the moveable member to the pump.

8. The system of claim 1, further comprising a second pumping mechanism, the second pumping mechanism comprising:
a flow-driven moveable member adapted to rotate in response to movement of a gaseous fluid body; and
a pump coupled to the moveable member and adapted to pressurize a pumping fluid in response to motion of the moveable member, the pump comprising:
a multi-chambered cylinder;
a plunger extending through the multi-chambered cylinder and driven by motion of the moveable member; and
a plurality of pistons coupled to the plunger, each piston disposed in a separate chamber of the multi-chambered cylinder, the plurality of pistons adapted to pressurize a pumping fluid in response to motion of the moveable member.

9. The system of claim 8, further comprising a conduit system for combining the pressurized pumping fluid from the first pumping mechanism and the second pumping mechanism and conveying the combined fluid to the power generation mechanism.

10. The system of claim 9, wherein the system is adapted to allow the second pumping mechanism to cease supplying pressurized pumping fluid while the first pumping mechanism continues supplying pressurized pumping fluid.

11. The system of claim 10, wherein the system is adapted to allow the second pumping mechanism to be replaced while the first pumping mechanism continues supplying pressurized pumping fluid.

12. The system of claim 9, further comprising a second conduit system for dispersing the fluid from the power generation mechanism to the pumping mechanisms.

13. The system of claim 12, further comprising:
a bypass conduit in communication with the first conduit system and the second conduit system; and
a bypass valve coupled to the bypass conduit, the bypass valve adapted to allow flow of the pressurized pumping fluid from the first conduit system to the second conduit system when a predetermined pressure of the pumping fluid is exceeded.

14. The system of claim 1, further comprising:
a second electrical power generation mechanism adapted to utilize the pressurized pumping fluid to generate electrical power;
a first conduit system configured to convey the pressurized pumping fluid away from the pumping mechanism;
a supply inlet for each of the power generation mechanisms; and
a flow selector coupled to the first conduit system and at least one of the supply inlets, the flow selector configured to control fluid flow to at least one of the power generation mechanisms based on the fluid pressure in the first conduit system.

15. The system of claim 14, wherein the flow selector comprises:
a valve in one of the supply inlets;
a sensor for sensing the fluid pressure in the first conduit system; and
a controller for generating a command for the valve based on the fluid pressure in the first fluid conduit system.

16. The system of claim 14, further comprising a second conduit system configured to convey the pressurized pumping fluid away from the electrical power generation mechanisms and to the pumping mechanism.

17. A method for utilizing movements of a gaseous fluid body to generate electrical power, the method comprising:
driving a multi-chambered pump using the motion of a flow-driven moveable member that rotates in response to movement of a gaseous fluid body;
pressurizing a pumping fluid with pistons located in the chambers of the pump;
conveying the pressurized pumping fluid to an electrical power generator mechanism; and
generating power with the electrical power generator mechanism using the pressurized pumping fluid.

18. The method of claim 17, further comprising:
combining the pressurized pumping fluid from the chambers; and
conveying the combined fluid to the electrical power generator mechanism.

19. The method of claim 17, further comprising providing the pumping fluid to an inner chamber of a housing from which the pump draws the fluid to be pressurized.

20. The method of claim 19, wherein the chamber serves as a reservoir for multiple cycles worth of the pumping fluid.

21. The method of claim 17, further comprising:
driving a second multi-chambered pump using the motion of a second flow-driven moveable member that rotates in response to movement of a gaseous fluid body;
pressurizing the pumping fluid with pistons located in the chambers of the second pump;
conveying the pressurized pumping fluid to the electrical power generator mechanism; and
generating power with the electrical power generator mechanism using the pressurized pumping fluid from the first pump and the second pump.

22. The method of claim 21, further comprising combining the pressurized pumping fluid from the first pump and the second pump before it arrives at the electrical power generator mechanism.

23. The method of claim 21, further comprising conveying the pumping fluid from the electrical power generator mechanism to the pumps.

24. The method of claim 21, further comprising ceasing to supply pressurized pumping fluid to the electrical power generator mechanism from the second pump while continuing to supply pressurized pumping fluid from the first pump.

25. The method of claim 17, further comprising:
conveying pressurized pumping fluid to a flow selector before conveying it to the electrical power generator mechanism; and
adjusting fluid flow to the electrical power generator mechanism and a second electrical power generator mechanism based on the pressure of the pumping fluid.

26. A system for utilizing movements of a gaseous fluid body to generate electrical power, the system comprising:
a first and a second pumping mechanism, each pumping mechanism comprising:
a flow-driven moveable member adapted to rotate in response to movement of a gaseous fluid body and comprising radially extending elements coupled to a hub and an alignment system adapted to align the member with fluid body movements,
a power conversion mechanism adapted to convey power from the moveable member to a pump, and
the pump coupled to the power conversion mechanism and adapted to pressurize a pumping fluid in response to motion of the moveable member, the pump comprising:
a multi-chambered cylinder;
a plunger extending through the multi-chambered cylinder and driven by motion of the moveable member;
a plurality of pistons coupled to the plunger, each piston disposed in a separate chamber of the multi-chambered cylinder, the plurality of pistons adapted to pressurize a pumping fluid in response to motion of the moveable member; and
each chamber including at least one fluid inlet conduit coupled to the chamber, a first one-way valve coupled to the at least one fluid inlet conduit, at least one fluid outlet conduit coupled to the chamber, and a second one-way valve coupled to the at least one fluid outlet conduit;
a first conduit system for combining the pressurized pumping fluid from the chambers and the pumps and conveying the combined fluid to a plurality of electrical power generation mechanisms;
the electrical power generation mechanisms adapted to utilize the pressurized pumping fluid to generate electrical power;
a second conduit system for dispersing the fluid from the power generation mechanism to the pumping mechanisms;
a supply inlet for each of the power generation mechanisms; and
a flow selector coupled to the first conduit system and at least one of the supply inlets, the flow selector configured to control fluid flow to at least one of the power generation mechanisms based on the fluid pressure in the first conduit system.
